(19) United States
(12) Patent Application Publication
(10) Pub. No.: US 2002/0064978 A1
(43) Pub. Date: May 30, 2002

(54) Ground connector

(75) Inventor: Robert De France, Poughkeepsie, NY (US)

Correspondence Address: ALIX YALE & RISTAS LLP, 750 MAIN STREET, SUITE 600, HARTFORD, CT, 06103

(73) Assignee: DELRI LLC

(21) Appl. No.: 09/726,829

(22) Filed: Nov. 30, 2000

(51) Int. Cl. H01R 4/66

(52) U.S. Cl. 439/100

(57) ABSTRACT

A ground connector for use with an associated distribution transformer which includes a base. The base includes apparatus for attaching the base to the associated distribution transformer and a fixed jaw. The ground connector also includes a movable jaw, the movable jaw includes first surfaces dimensioned and configured for engagement with second surfaces of the base to guide movement of the movable jaw with respect to the base. The movable jaw moves generally radially with respect to the associated distribution transformer to secure an associated cable intermediate the fixed jaw and the movable jaw when the ground connector is installed on an associated distribution transformer. The fixed jaw and the movable jaw hold the associated cable generally tangentially to the associated distribution transformer when the ground connector is installed on an associated distribution transformer. In some forms of the invention at least one of the first and second surfaces includes at least one elongated rib. The at least one of the first and second surfaces may include at least a second elongated rib.

### BACKGROUND OF THE INVENTION

The invention relates to electrical power distribution systems and particularly to attachments for grounding distribution transformers.

Distribution transformers are typically mounted on so-called telephone or utility poles that carry electrical power to local areas. Although such distribution transformers are most visible in residential and commercial locations, it will be understood that the ground connection in accordance with the present invention has application to other electrical connections in other locations as well as to other transformers and other applications that are not related to transformers. In the case of distribution transformers it is vital to maintain a positive ground connection. Failure to maintain a positive ground connection will ordinarily result in the destruction of the transformer and in some cases even fires and other catastrophes. Failure of the transformer will at least cause a power failure. In the worst case a fire may result which may or may not be localized. When the fire spreads there is a significant risk of personal injury. Another risk associated with the loss of the ground connection on such transformers is the risk of injury to linemen who may inadvertently touch the transformer and may be severely shocked or electrocuted. Thus, it is of great importance for transformers and other devices to have a very reliable ground connection.

The prior art to which the invention relates includes a wide variety of devices for making electrical connections. Such devices have not, in general, been wholly satisfactory.

It is of great importance to provide apparatus that will maintain a very positive connection of high integrity for long periods of time. It is also a great importance to have apparatus that will maintain the connection without maintenance because of the difficulty of accessing the connection that is typically on a utility pole. Because of this location of the ground connector, checking the condition of the connection is problematic. The difficulty is accentuated by the location on a pole as well as the significant precautions, which must be taken to avoid electrocution. The relative inaccessibility of the connection and the significant safety precautions which must be taken to avoid electrocution make it particularly desirable to provide apparatus which can be used with a minimum effort.

An additional design consideration is a very competitive marketplace. It is therefore desirable to provide structure that can be manufactured at a competitive price and installed in an efficient cost-effective manner. The typical ground connector is manufactured a material that includes at least some copper. Because copper is relatively expensive, it is desirable to provide a structure that utilizes less material than known prior art structures.

A typical distribution transformer has a one-half inch nut welded to the housing thereof for providing the ground connection. Thus, it is vital that apparatus for such an application cooperates with the one-half inch nut that is welded to the transformer housing.

### SUMMARY OF THE INVENTION

An object of the invention is to provide apparatus which will provide a very positive ground connection that can be maintained for long periods of time without the need for inspection by linemen.

Another object of the invention is to provide apparatus which can be manufactured in an efficient and cost effective manner and which utilizes less material than known ground connectors.

A further object of the invention is to provide apparatus which can be efficiently installed and connected to an associated ground wire.

It has now been found that these and other objects of the invention may be attained in a ground connector for use with an associated distribution transformer which includes a base. The base includes apparatus for attaching the base to the associated distribution transformer and a fixed jaw. The ground connector also includes a movable jaw, the movable jaw includes first surfaces dimensioned and configured for engagement with second surfaces of the base to guide movement of the movable jaw with respect to the base. The movable jaw moves generally radially with respect to the associated distribution transformer to secure an associated cable intermediate the fixed jaw and the movable jaw when the ground connector is installed on an associated distribution transformer. The fixed jaw and the movable jaw hold the associated cable generally tangentially to the associated distribution transformer when the ground connector is installed on an associated distribution transformer.

In some forms of the invention at least one of the first and second surfaces includes at least one elongated rib. The at least one of the first and second surfaces may include at least a second elongated rib. In some forms of the invention the at least one of the first and second surfaces, that does not have an elongated rib disposed thereon, does have an elongated channel dimensioned and configured for engagement with one of the elongated ribs. Some forms of the invention may have at least one of the first and second surfaces, that does not have an elongated rib disposed thereon, and which does have an elongated channel dimensioned and configured for engagement with one of the elongated ribs.

Some embodiments of the apparatus in accordance with the invention may include a first bolt extending through the movable jaw and engaging a threaded bore in the base to permit tightening of the ground connector on an associated cable. The first bolt may have an axis and the axis of the first bolt may be disposed in substantially radial relationship to the associated distribution transformer when the ground connector is installed on an associated distribution transformer.

The ground connector may have apparatus for attaching the base to the associated distribution transformer that includes a stud. The stud may have an axis and the axis of the stud and the axis of the first bolt are parallel. The axis of the stud and the axis of the first bolt may be coplanar. The apparatus for attaching the base to the associated distribution transformer may include an aperture in the base for receiving an associated second bolt dimensioned and configured for engagement with the associated nut on the distribution transformer. The associated second bolt, which may be dimensioned and configured for engagement with the associated nut on the distribution transformer, has an axis that is parallel to the axis of the associated first bolt when the ground connector is installed on an associated distribution transformer.

### BRIEF DESCRIPTION OF THE DRAWING

The invention will better understood by reference the accompanying drawing in which:

FIG. 1 is a perspective view of a first embodiment of a ground connector in accordance with the present invention.

FIG. 2 is an exploded view of the apparatus illustrated FIG. 1, and which illustrates the cooperating ribs and channels respectively in the jaw and base of the connector.

FIG. 3 is a perspective view of the apparatus illustrated in FIG. 1 and 2, illustrating how the first embodiment cooperates with an associated ground cable and with an associated distribution transformer.

FIG. 4A is a perspective view of a second embodiment of a ground connector in accordance with the present invention.

FIG. 4B is an exploded view of the apparatus shown in FIG. 4A.

FIG. 5 is a perspective view of the apparatus illustrated FIGS. 4A and 4B, illustrating how the second embodiment cooperates with an associated ground cable and associated distribution transformer.

FIG. 6A is a perspective view of a third embodiment of the ground connector in accordance with the present invention.

FIG. 6B is an exploded view of the apparatus shown in FIG. 6A.

FIG. 7 is an elevation view of a typical installation of a distribution transformer and power line and which illustrates a preferred environment in which the apparatus in accordance with the present invention is utilized.

### DESCRIPTION OF THE PREFERRED EMBODIMENTS

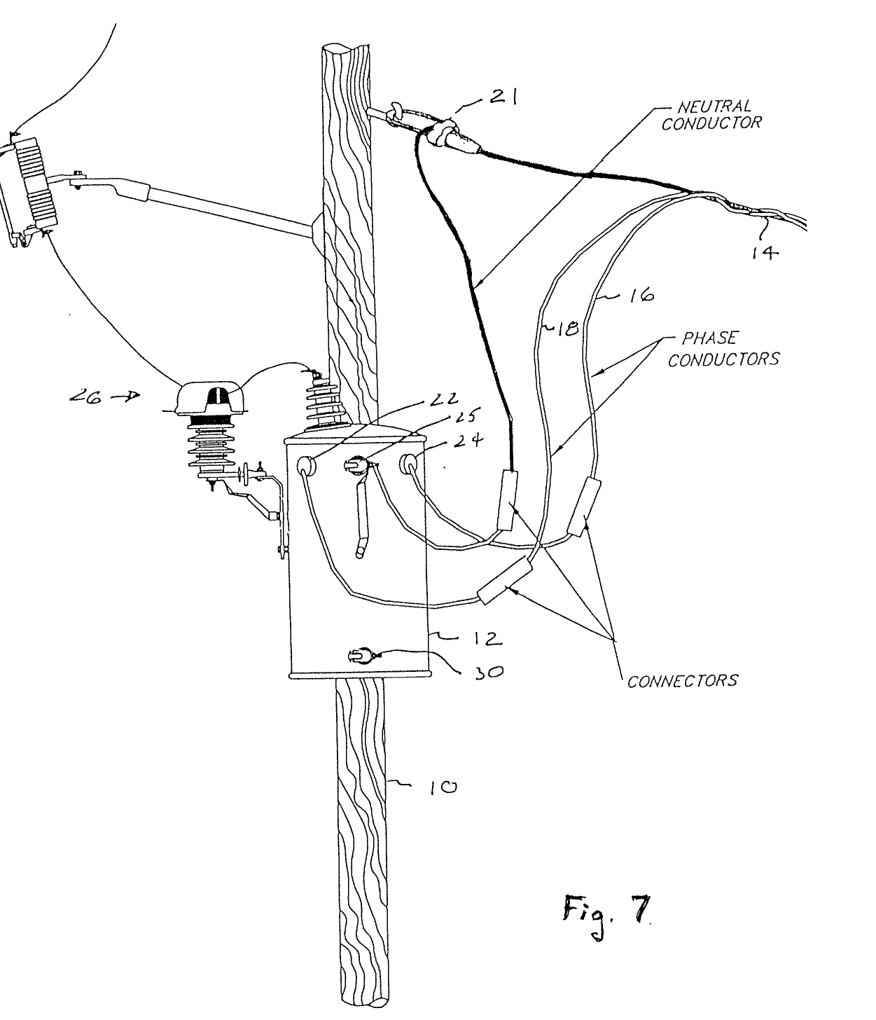

Referring now to FIG. 7, there is shown a typical utility pole 10 on which is mounted a generally cylindrical distribution transformer 12. A power line 14 includes phase conductors 16, 18 as well as a neutral conductor 20. The phase conductors 16, 18 and neutral conductor 20 are fixed to the distribution transformer 12 at connections 22, 24, and 25. A dead end 21 secures the cable 14 to the utility pole 10. The typical installation illustrated in FIG. 7 includes a lightning arrestor system 26. In the typical manner a nut 30 is welded on the distribution transformer 12 near the lower axial extremity thereof.

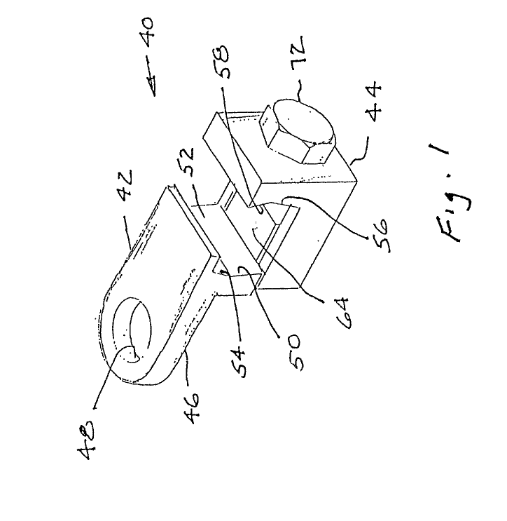

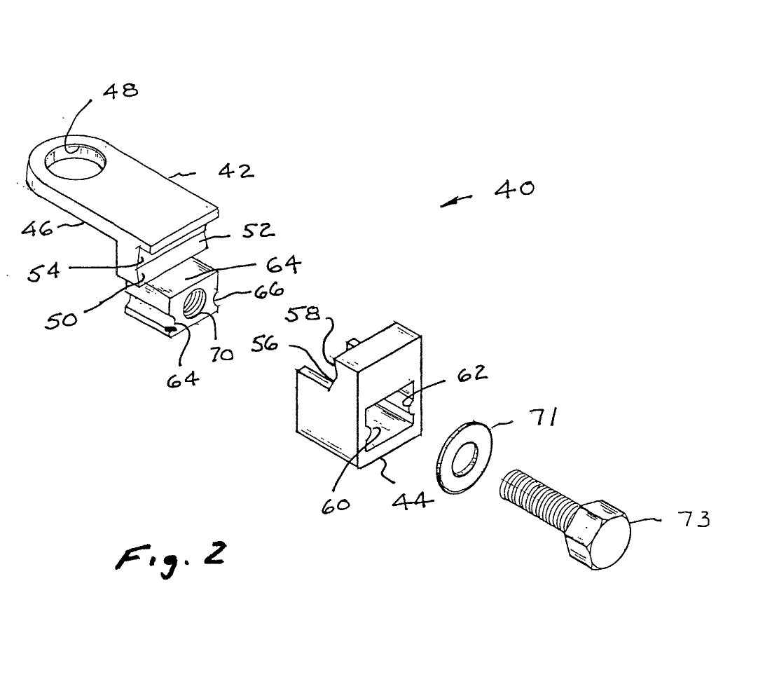

The connector 40 illustrated in FIGS. 1, 2, and 3 includes a base 42 and a movable jaw 44. The base 42 includes a spade shaped member having an aperture 48 disposed therein. The aperture 48 is dimensioned and configured for receiving a bolt 49 that also engages a nut 30 that is welded to the housing of the distribution transformer 12. The base 42 also includes a fixed jaw 50 that cannot move relative to the aperture 48. Accordingly, when the ground connector 40 is fixed to the nut 30 by the bolt 49, the fixed jaw 50 is fixed with respect to the nut 30 as well as the aperture 48. The fixed jaw 50 includes intersecting planar faces 52 and 54 having included angle therebetween of approximately 140 degrees. The movable jaw 44 includes planar faces 56, 58 having included angle therebetween of approximately 140 degrees. As best seen in FIG. 2, the movable jaw 44 is provided with ribs 60, 62 disposed on opposed sides of a generally channel shaped part of the movable jaw 42. The opposed ribs 60, 62 engage and cooperate with channels 64, 66 formed in a guide part 64 of the base 42. The guide part 64 also includes a threaded bore 70 that receives the bolt 73 (on which the washer 71 is disposed). Accordingly, the user can tighten the movable jaw 44 with respect to the fixed jaw 52 by turning the bolt 73.

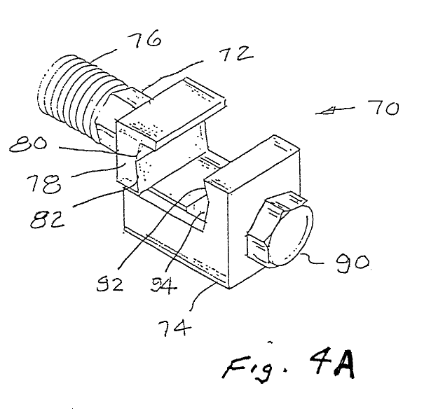

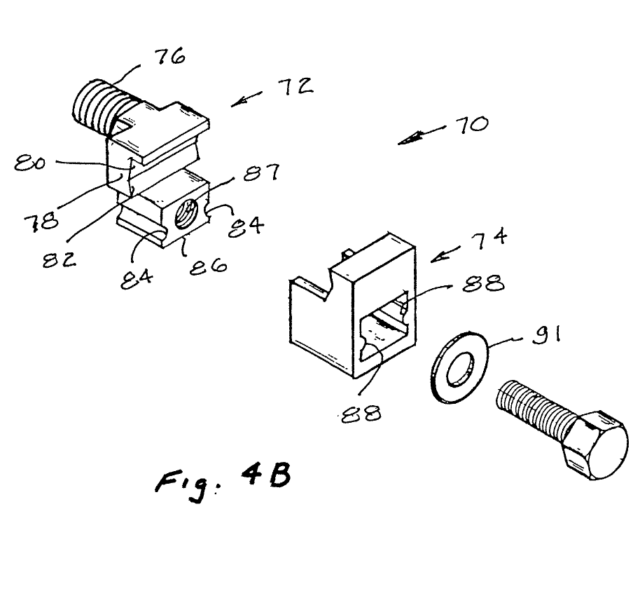

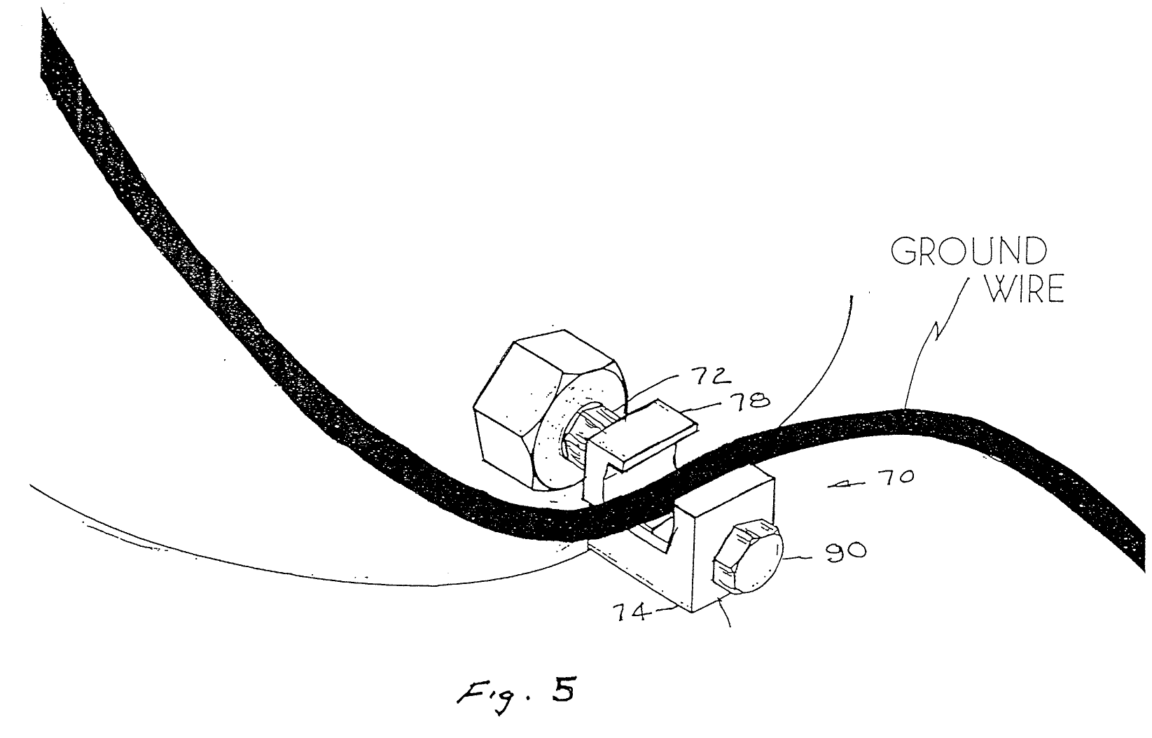

Referring now to FIGS. 4A, 4B and 5, there is shown a connector 70 in accordance with a second embodiment of the present invention. The connector 70 includes a base 72 and a movable jaw 74. The base 72 includes a stud 76 dimensioned and configured for engagement with the nut 30 welded on the associated distribution transformer 12. In a manner generally similar to the construction of the connector 40 the base 72 includes a fixed jaw 78 that cannot move relative to the stud 76. The fixed jaw 78 includes two generally planar intersecting faces 80, 82. As best seen in FIG. 4B, the fixed jaw 72 includes a depending portion or guide part 86 having opposed sides provided with respective channels 84.

As best seen in FIG. 4B, the connector 70 includes structure on the movable jaw 74 for cooperation with channels 84. More specifically, the movable jaw 74 includes a portion that is generally channel shaped with opposing walls that are provided with opposed ribs 88, 88 dimensioned and configured for engagement with the channels 84. A bolt 90, on which a washer 91 is disposed, extends through the movable jaw 74 and engages a threaded bore 87 in the guide part 86 of the base 72. The movable jaw 74 includes two generally planar intersecting faces 92, 94. It will thus be seen that the user may tighten the nut 90 to cause the movable jaw 74 to urge the ribs 88, 88 of the movable jaw 74 to move with respect to the channels 84, 84 of the base 72. The channels 84, 84 and the ribs 88, 88 provide proper alignment of the base 72 and a movable jaw 74. This second embodiment is particularly desirable in that the stud 76 easily engages the nut 30 on the distribution transformer 12. Even more importantly, when used in this manner it is particularly convenient for a linemen to place a cable intermediate the intersecting faces 92, 94 of the movable jaw 74 as well as the intersecting faces 80, 82 of the fixed jaw 78 that is part of the base 72. In other words, the intersection of the generally planar surfaces 80, 82 defines a line that is parallel to a plane (not shown) that is tangent to the distribution transformer at the nut 30. Similarly, the intersection of the generally planar surfaces 92, 94 defines a line that is also parallel to a change in to the distribution transformer at the nut 30. The convenience of such placement is particularly important because of (1) the relatively dangerous environment in which the linemen must work and (2) the inherent awkwardness of working at the top of a utility pole. It will be seen in this embodiment the axis of the bolt 90 and the axis of the stud 76 are parallel. In other words the axis of the bolt 90 and the axis of the stud 76 are coplanar.

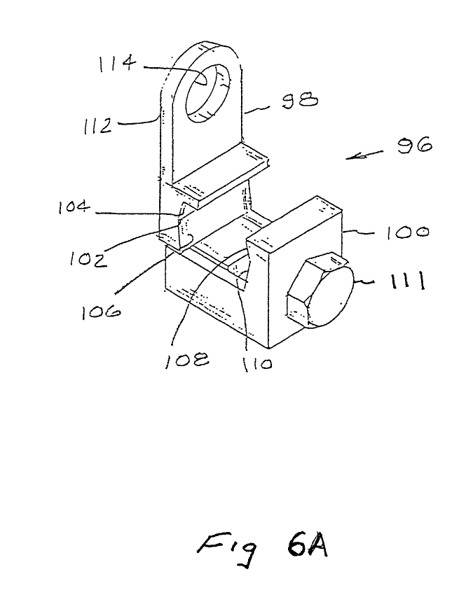

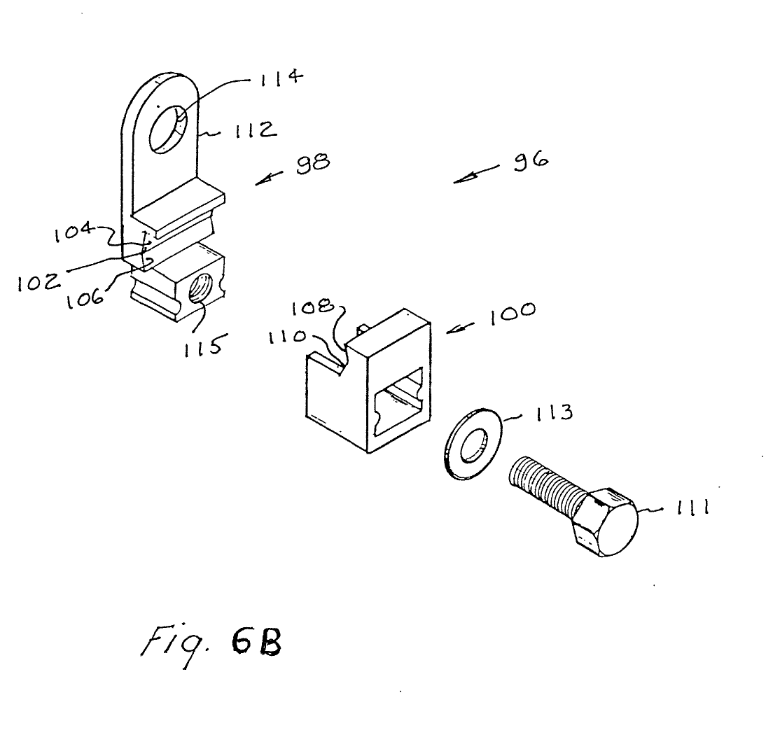

Referring now to FIGS. 6A and 6B, there is shown a third embodiment of the apparatus in accordance with present invention. This connector 96 includes a base 98 and a movable jaw 100. As in the other embodiments, the base 98 includes a fixed jaw 102. The fixed jaw 102 has intersecting generally planar faces 104 and 106. Also, as in the other embodiments, the generally planar faces 104 and 106 intersect with an included angle of approximately 140 degrees. The intersection of the generally planar faces 104 and 106 defines a line that is parallel to a plane (not shown) that is tangent to the face of the distribution transformer at the nut 30. The movable jaw includes generally planar intersecting faces 108 and 110 having included angle therebetween of approximately 140 degrees. The intersection of the generally planar intersecting faces 108 and 110 defines a line that is also parallel to a plane (not shown) that is tangent to the distribution transformer at the nut 30 on the side of the distribution transformer. The base 98 includes a spade shaped portion 112. An aperture 114 therein is dimensioned and configured for receiving a bolt that will engage the nut 30 on the distribution transformer 12. This embodiment also employs cooperating ribs and channels to guide the relative movement of the movable jaw 100 with respect to the base 98. A bolt 111, on which is disposed a washer 113, extends through the movable jaw into a threaded bore 115 in the base 98. It will be seen that this embodiment is also particularly convenient for a linemen to use because of the orientation of the jaws.

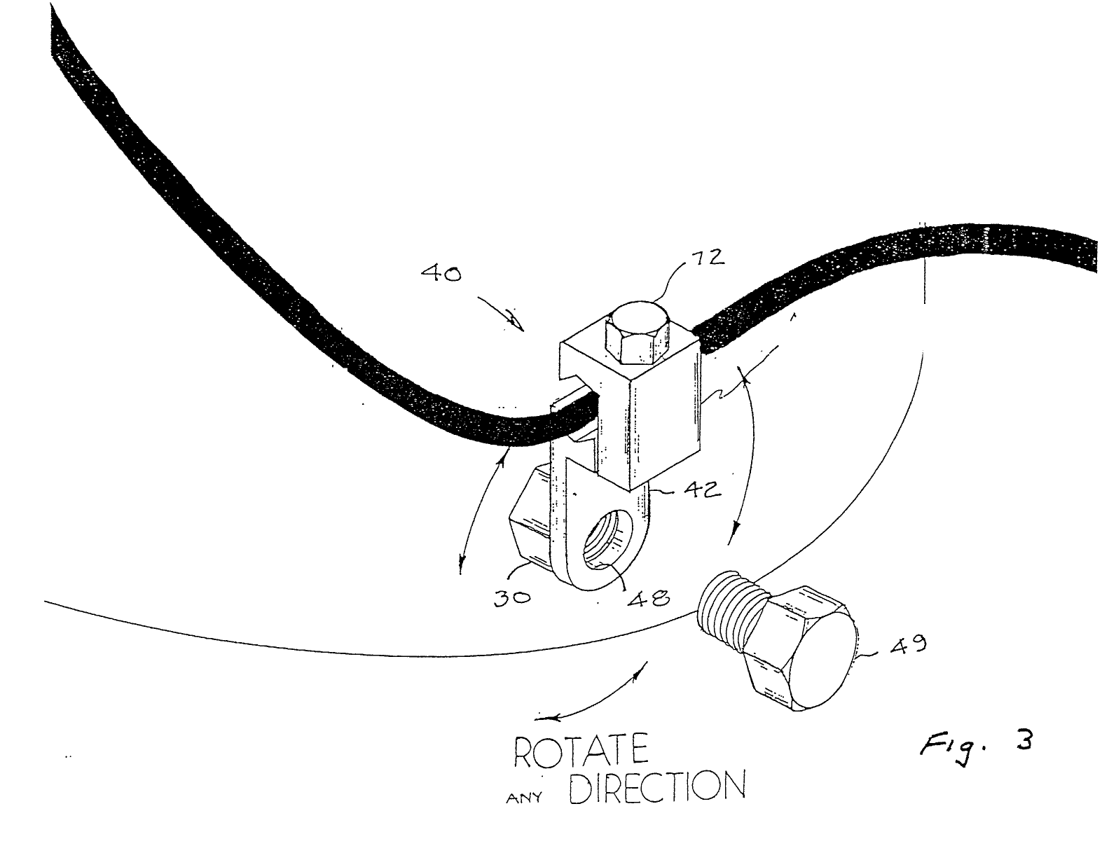

It will be seen that all embodiments of the present invention have jaws mounted to hold the ground cable in substantially tangential relationship to a side of the distribution transformer. The ground cable typically extends around the distribution transformer to the ground connector on the base of the transformer and then to actual ground in the manner generally shown in FIG. 3. The positioning of the jaws to hold the cable in tangential relationship to the transformer is a desirable benefit of the apparatus in accordance with present invention. Such an arrangement is convenient for the linemen and in addition neatly holds the ground cable.

While the present invention has been described with reference to the preferred embodiments illustrated in the drawing, the detailed description thereof is not intended to limit the scope of the invention as claimed in the appended claims.

What is claimed:

1. A ground connector for use with an associated distribution transformer which comprises:
a base, said base including means for attaching said base to the associated distribution transformer, said base including a fixed jaw; and
a movable jaw, said movable jaw including first surfaces dimensioned and configured for engagement with second surfaces of said base to guide movement of said movable jaw with respect to said base, said movable jaw moving generally radially with respect to the associated distribution transformer to secure an associated cable intermediate said fixed jaw and said movable jaw when said ground connector is installed on an associated distribution transformer, said fixed jaw and said movable jaw holding the associated cable generally tangentially to the associated distribution transformer when said ground connector is installed on an associated distribution transformer.

2. A ground connector in accordance with claim 1, wherein at least one of said first and second surfaces includes at least one elongated rib.

3. A ground connector in accordance with claim 2, wherein said at least one of said first and second surfaces includes at least a second elongated rib.

4. A ground connector in accordance with claim 3, wherein at least one of said first and second surfaces, that does not have an elongated rib disposed thereon, does have an elongated channel dimensioned and configured for engagement with one of said elongated ribs.

5. A ground connector in accordance with claim 4, wherein at least one of said first and second surfaces, that does not have an elongated rib disposed thereon, does have any elongated channel dimensioned and configured for engagement with one of said elongated ribs.

6. A ground connector in accordance with claim 5, further including a first bolt extending through said movable jaw and engaging a threaded bore in said base to permit tightening of said ground connector on an associated cable.

7. A ground connector in accordance with claim 6, wherein said first bolt has an axis and said axis of said first bolt is disposed in substantially radial relationship to the associated distribution transformer when the ground connector is installed on an associated distribution transformer.

8. A ground connector in accordance with claim 5, wherein said means for attaching said base to the associated distribution transformer includes a stud.

9. A ground connector in accordance with claim 8, wherein said stud has an axis and the axis of said stud and said axis of said first bolt are parallel.

10. A ground connector in accordance with claim 9, wherein the axis said stud and the axis of said first bolt are coplanar.

11. A ground connector for use with an associated distribution transformer which comprises:
a base, said base including means for attaching said base to the associated distribution transformer, said base including a fixed jaw; and
a movable jaw, said movable jaw including first surfaces dimensioned and configured for engagement with second surfaces of said base to guide movement of said movable jaw with respect to said base, said fixed jaw and said movable jaw holding the associated cable generally tangentially to the associated distribution transformer when said ground connector is installed on an associated distribution transformer, at least one of said first and second surfaces includes at least one elongated rib, at least one of said first and second surfaces includes at least a second elongated rib, at least one of said first and second surfaces, that does not have an elongated rib disposed thereon, does have an elongated channel dimensioned and configured for engagement with one of said elongated ribs, at least one of said first and second surfaces, that does not have an elongated rib disposed thereon, does have any elongated channel dimensioned and configured for engagement with one of said elongated ribs, further including a threaded bore on an associated cable, said means for attaching said base to the associated distribution transformer includes an aperture in said base for receiving an associated second bolt dimensioned and configured for engagement with the associated nut on the distribution transformer.

12. A ground connector in accordance with claim 11, wherein the associated second bolt is dimensioned and configured for engagement with the associated nut on the distribution transformer has an axis that is parallel to the axis of the associated first bolt when the ground connector is installed on associated distribution transformer.

13. A ground connector in accordance with claim 12, wherein the axis of the associated second bolt and the axis of the associated first bolt are coplanar wherein the ground connector is installed on an associated distribution transformer.

14. A ground connector in accordance with claim 2, wherein said at least one of said first and second surfaces that includes at least one elongated rib is one of said second surfaces.

15. A ground connector in accordance with claim 3, wherein said at least one of said first and second surfaces that includes at least a second elongated rib is one of said second surfaces.

16. A ground connector in accordance with claim 3, wherein said at least one of said first and second surfaces, that does not have an elongated rib disposed thereon and does have an elongated channel dimensioned and configured for engagement with one of said elongated ribs is one of said first surfaces.

17. A ground connector in accordance with claim 4, wherein said at least one of said first and second surfaces, that does not have an elongated rib disposed thereon and does have an elongated channel dimensioned and configured for engagement with one of said elongated ribs is one of said first surfaces.

18. A ground connector for use with an associated generally cylindrical distribution transformer which comprises:
a base, said base including means for attaching said ba se to the associated distribution transformer, said base including a fixed jaw; and
a movable jaw, said movable jaw including first surfaces dimensioned and configured for engagement with second surfaces of said base to guide movement of said movable jaw with respect to said base, said movable jaw moving generally axially with respect to the associated distribution transformer to secure an associated cable intermediate said fixed jaw and said movable jaw, said fixed jaw and said movable jaw holding the associated cable generally tangentially to the associated distribution transformer when said ground connector is installed on an associated distribution transformer.

19. A ground connector in accordance with claim 18, wherein at least one of said first and second surfaces includes at least one elongated rib.

20. A ground connector in accordance with claim 19, wherein said at least one of said first and second surfaces includes at least a second elongated rib.

21. A ground connector in accordance with claim 20, wherein at least one of said first and second surfaces, that does not have an elongated rib disposed thereon, does have an elongated channel dimensioned and configured for engagement with one of said elongated ribs.

22. A ground connector in accordance with claim 21, wherein at least one of said first and second surfaces, that does not have an elongated rib disposed thereon, does have any elongated channel dimensioned and configured for engagement with one of said elongated ribs.

23. A ground connector in accordance with claim 22 further including a first bolt extending through said movable jaw and engaging a threaded bore in said base to permit tightening of said ground connector on an associated cable.

24. A ground connector in accordance with claim 23, wherein said first bolt has an axis and said axis of said first bolt is disposed parallel relationship to the axis associated distribution transformer when the ground connector is installed on an associated distribution transformer.

25. A ground connector in accordance with claim 21, wherein said means for attaching said base to the associated distribution transformer includes an aperture in said base for receiving an associated second bolt dimensioned and configured for engagement with the associated nut on the distribution transformer.

26. A ground connector in accordance with claim 25, wherein the associated second bolt is dimensioned and configured for engagement with the associated nut on the distribution transformer has an axis that is perpendicular to the axis of the associated first bolt when the ground connector is installed on associated distribution transformer.

27. A ground connector in accordance with claim 26, wherein the axis of the associated second bolt and the axis of the associated first bolt are coplanar wherein the ground connector is installed on an associated distribution transformer.

28. A ground connector installation which comprises:
a distribution transformer having a generally cylindrical shape defining an axis; and
a base mounted to said transformer, said base including means for attaching said base to the associated distribution transformer, said base including a fixed jaw; and
a movable jaw, said movable jaw including first surfaces dimensioned and configured for engagement with second surfaces of said base to guide movement of said movable jaw with respect to said base, said movable jaw movable generally radially with respect to the associated distribution transformer to secure an associated cable intermediate said fixed jaw and said movable jaw, said fixed jaw and said movable jaw holding the associated cable in generally tangential relationship to the associated distribution transformer.

29. A ground connector in accordance with claim 28, wherein at least one of said first and second surfaces includes at least one elongated rib.

30. A ground connector in accordance with claim 29, wherein said at least one of said first and second surfaces includes at least a second elongated rib.

31. A ground connector in accordance with claim 30, wherein at least one of said first and second surfaces, that does not have an elongated rib disposed thereon, does have an elongated channel dimensioned and configured for engagement with one of said elongated ribs.

32. A ground connector in accordance with claim 31, wherein at least one of said first and second surfaces, that does not have an elongated rib disposed thereon, does have any elongated channel dimensioned and configured for engagement with one of said elongated ribs.

33. A ground connector in accordance with claim 32, further including a first bolt extending through said movable jaw and engaging a threaded bore in said base to permit tightening of said ground connector on an associated cable.

34. A ground connector in accordance with claim 33, wherein said first bolt has an axis and said axis of said first bolt is disposed in substantially parallel relationship to the axis of the associated distribution transformer.

35. A ground connector in accordance with claim 34, wherein said means for attaching said base to the associated distribution transformer includes an aperture in said base for receiving an associated second bolt dimensioned and configured for engagement with the associated nut on the distribution transformer.

36. A ground connector in accordance with claim 35, wherein the associated second bolt is dimensioned and configured for engagement with the associated nut on the distribution transformer has an axis that is perpendicular to the axis of the associated first bolt when the ground connector is installed on associated distribution transformer.

37. A ground connector in accordance with claim 36, wherein at least one of said first and second surfaces includes at least one elongated rib.
